(19) United States
(12) Patent Application Publication
(10) Pub. No.: US 2023/0420781 A1
(43) Pub. Date: Dec. 28, 2023

(54) Battery Block Fixing Device For Energy Storage Power Supply

(71) Applicant: Beijing Union Ophthalmic Device Technology Service Co. Ltd., Beijing (CN)

(72) Inventor: Bin Chang, Beijing (CN)

(21) Appl. No.: 18/180,035

(22) Filed: Mar. 7, 2023

(30) Foreign Application Priority Data
Jun. 27, 2022 (CN) 202210743160X

(51) Int. Cl. H01M 50/244; H01M 50/24; H01M 50/291; H01M 50/204; H01M 10/6557; H01M 10/6563

(52) U.S. Cl. CPC H01M 50/244; H01M 50/24; H01M 10/6563; H01M 50/204; H01M 10/6557; H01M 50/291

(57) ABSTRACT

The present disclosure provides a battery block fixing device for an energy storage power supply, which includes an A housing, a handle is fixedly mounted on a top of the A housing, a bottom of the A housing is provided with a B housing, a C housing, a D housing and an E housing in sequence, and the A housing, the handle, the B housing, the C housing, the D housing and the E housing are all detachably connected. The fans on both sides rotate to blow wind into the placing box, and the fan on the right blows wind to the left, the airflow flows from the upper half of the fixing plate to the left of the fixing plate, flows through the gap between the batteries, then flows towards the lower part of the fixing plate after passing through the through hole.

### TECHNICAL FIELD

The present disclosure relates to the technical field of energy storage power supplies, in particular to a battery block fixing device for the energy storage power supply.

### BACKGROUND

The energy storage battery, also known as the accumulator, is internally provided with multiple batteries to supply power to equipment. The energy storage battery is internally provided with fixing members to fix and space the batteries, and an external portion of the energy storage battery is provided with a heat dissipation member to facilitate the discharge of heat from the batteries.

When the batteries are cooled by the external heat dissipation member, wind generated by a fan is prone to form a convection in the energy storage battery, which increases the stay time of the airflow inside the housing and reduces the heat dissipation effect of the batteries. Moreover, after the batteries are used for a long time, the batteries are prone to bulge, and it is easy to cause potential safety hazards if the bulge is not found and repaired in time.

By setting fixing members in the energy storage battery, the fixing members can fix and space the batteries, resist collision to prevent the battery from shaking, and guide the airflow generated by heat dissipation member, so that the airflow flows in one direction, which ensures the heat dissipation effect of the batteries, and whether the bulge is occurred on the batteries is monitored, thus the present disclosure provides a battery block fixing device for the energy storage power supply.

### SUMMARY

### (1) Technical Problems to be Solved

In view of the shortcomings of the prior art, the present disclosure provides a battery block fixing device for an energy storage power supply, which has the advantages of ensuring the heat dissipation effect of the battery and monitoring the occurrence of the bulges of the batteries, etc., the present disclosure can solve the problem of poor heat dissipation effect of the battery, and can also solve the problem of that it is difficult to detect the bulge.

### (2) Technical Solutions

In order to achieve the above purposes of ensuring the heat dissipation effect of the battery and monitoring the bulge on the batteries, the present disclosure provides the following technical solutions: a battery block fixing device for an energy storage power supply includes an A housing, a handle is fixedly mounted on a top of the A housing, a bottom of the A housing is provided with a B housing, a C housing, a D housing and an E housing in sequence, and the A housing, the handle, the B housing, the C housing, the D housing and the E housing are all detachably connected.

Preferably, the D housing includes a placing box, a top housing is fixedly mounted on a top of the placing box, a bottom housing is fixedly mounted on a bottom of the placing box, the placing box is internally provided with a fixing member, and the fixing member is internally provided with batteries arranged in array, left and right sides of the placing box are fixedly mounted with heat dissipation members, the top housing is fixedly mounted on a bottom of the C housing, and the bottom housing is fixedly mounted on a top of the E housing.

Preferably, an inner wall of a bottom of the placing box is integrally formed with a base bracket, the left and right sides of the placing box define air inlets extending through the left and right sides, left and right side walls of the placing box are fixedly mounted with wedge blocks, and top surfaces of the wedge blocks are inclined surfaces, the two wedge blocks are staggered from each other in a vertical direction, and front and rear sides of the bottom housing define strip grooves arranged in arrays.

Preferably, the fixing member includes a fixing plate, a middle of the fixing plate is horizontal, a left side of the fixing plate is inclined upward, a right side of the fixing plate is inclined downward, and the left and right sides of the fixing plate are respectively butted against the tops of two wedge blocks, the middle of the fixing plate defines circular holes arranged in array, the batteries are inserted into the circular holes, opening parts are provided on upper and lower sides of the fixing plate and arranged at openings of the circular holes, a left inclined surface of the fixing plate defines a through hole, and a support plate is arranged directly below the fixing plate and butted on the base bracket, a guiding hole is arranged in a right side of the support plate, a pressing plate is arranged above the fixing plate and butted on tops of the batteries, and the left and right sides of the fixing plate and left and right side walls of the placing box are provided with support parts.

Preferably, mounting grooves arranged in an array are defined in a surface of the fixing plate and defined in an inner wall of the circular hole, a sliding rod is slidably connected in the mounting groove, an end of the sliding rod is fixedly mounted with an arc plate, the arc plate is butted against a surface of the battery, a side of the arc plate away from the sliding rod is arranged with rubber protrusions arranged in an array, a surface of the sliding rod is sleeved with a second spring, two ends of the second spring are fixedly mounted on the surface of the sliding rod and an inner wall of the mounting groove, the other end of the sliding rod is fixedly mounted with a contacting head, a bottom of the mounting groove is provided with a contacting plate, the contacting head is electrically connected with the contacting plate, the D housing is internally provided with an alarm, and the contacting head, the contacting plate and the alarm are connected in series.

Preferably, the support part includes a sleeving tube fixedly mounted on a side wall of the placing box, an end face of the sleeving tube is fixedly mounted with a first spring, the other end of the first spring is fixedly mounted with an inserting rod and an end of the inserting rod away from the first spring is inclined, and the inserting rod is butted against an inclined surface of the fixing plate.

Preferably, the heat dissipation member includes fan covers fixedly mounted on the left and right sides of the placing box, a fan is arranged between the fan cover and the side of the placing box, and an avoiding opening extends through a surface of the fan cover, and the air inlet communicates with the placing box and the fan cover.

### (3) Beneficial Effects

Compared with the prior art, the present disclosure provides a battery block fixing device for an energy storage power supply, which has the following beneficial effects:

1. The battery block fixing device for the energy storage power supply is used to store the batteries through the circular holes defined in the fixing plate. When the placing box collides with an object and the batteries tend to shake from left to right, the inclined parts on both sides of the fixing plate are butted to the left and right side walls of the placing box, and the elasticity of the first spring is used to support the inserting rod on the inclined surface of the fixing plate to prevent the batteries from shaking. So the batteries can be prevented from shaking.

2. The battery block fixing device for the energy storage power supply has the fans arranged on both sides, the fans rotate to blow wind into the placing box, and the fan on the right blows wind to the left, the airflow flows from the upper half of the fixing plate to the left of the fixing plate, flows through the gap between the batteries, then flows through the through hole, and flows towards the lower part of the fixing plate. The fan on the right blows wind to the left, so that the airflow flows through the gap between the batteries, then flows into the bottom housing after passing through the guiding hole, then the airflow is discharged from the bottom housing through the strip groove. So that an annular airflow is formed inside the placing box under the separation and guidance of the fixing plate, the airflow distance is increased, and the heat dissipation effect of the battery is ensured.

3. For the battery block fixing device for the energy storage power supply, when the battery bulges, the assembly of the arc plate and the sliding rod is pushed outward, so that the contacting head is in contact with the contacting plate, the contacting head and the contacting plate are coupled with the circuit where the alarm is located, so that the alarm gives an alarm, so as to achieve the effect of monitoring the bulge of the battery.

### BRIEF DESCRIPTION OF THE DRAWINGS

FIG. 1 is a structure diagram of a battery block fixing device for an energy storage power supply provided by the present disclosure;

FIG. 2 is a main cross sectional diagram of a D housing of the battery block fixing device for the energy storage power supply provided by the present disclosure;

FIG. 3 is a main cross sectional diagram of a placing box of the battery block fixing device for the energy storage power supply provided by the present disclosure;

FIG. 4 is a main cross sectional diagram of a heat dissipation member of the battery block fixing device for the energy storage power supply provided by the present disclosure;

FIG. 5 is an enlarged diagram of portion A in FIG. 3 of the battery block fixing device for the energy storage power supply provided by the present disclosure;

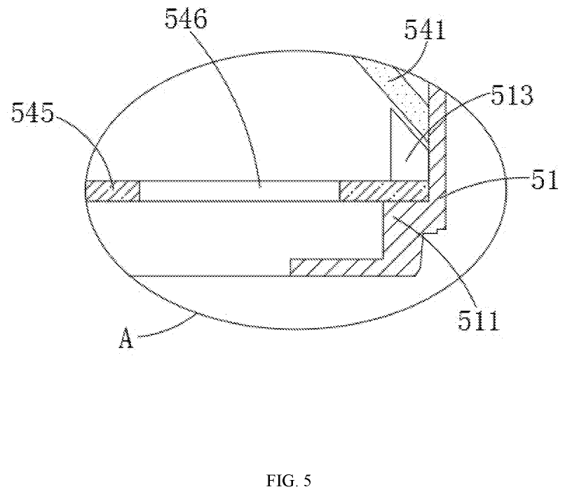

FIG. 6 is a cross sectional diagram from the top plan view of the circular holes of the fixing plate of the battery block fixing device for the energy storage power supply provided by the present disclosure.

In the figures: 1, A housing; 2, handle; 3, B housing; 4, C housing; 5, D housing; 6, E housing; 51, placing box; 52, top housing; 53, bottom housing; 54, fixing member; battery; 56, heat dissipation member; 511, base bracket; 512, air inlet; 513, wedge block; 531, strip groove; 541, fixing plate; 542, circular hole; 5421, mounting groove; 5422, sliding rod; 5423, arc plate; 5424, rubber protrusion; 5425, second spring; 5426, contacting head; 5427, contacting plate; 543, opening part; 544, through hole; 545, support plate; 546, guiding hole; 547, pressing plate; 548, support part; 5481, sleeving tube; 5482, first spring; 5483, inserting rod; 561, fan; 562, fan cover; 563, avoiding opening.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

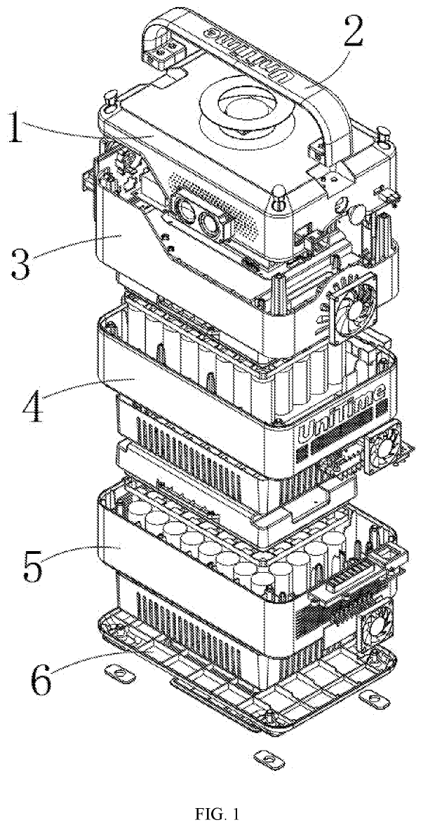

Referring to FIG. 1, a battery block fixing device for an energy storage power supply includes an A housing 1, a handle 2 is fixedly mounted on a top of the A housing 1, a bottom of the A housing 1 is provided with a B housing 3, a C housing 4, a D housing 5 and an E housing 6 in sequence. The C housing 4 is same with the D housing 5 in structure. The A housing 1, the handle 2, the B housing 3, the C housing 4, the D housing 5 and the E housing 6 are all detachably connected. The number of battery packs can be reduced by disassembling C housing 4 or D housing 5, or the number of battery packs can be increased by assembling C housing 4 and D housing 5, to meet the requirements of different battery capacities.

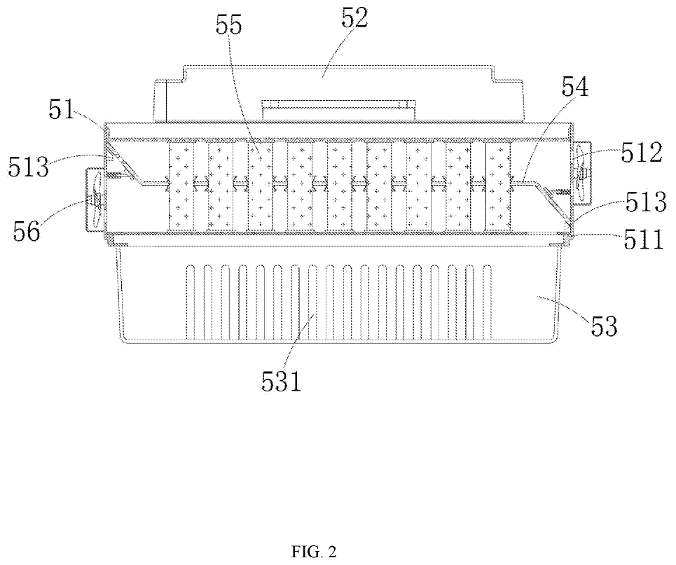

As shown in FIGS. 1-2, the D housing 5 includes a placing box 51, a top housing 52 is fixedly mounted on a top of the placing box 51, a bottom housing 53 is fixedly mounted on a bottom of the placing box 51, an inner wall of a bottom of the placing box 51 is integrally formed with a base bracket 511, the left and right sides of the placing box 51 define air inlets 512 extending through the left and right sides, left and right side walls of the placing box 51 are fixedly mounted with wedge blocks 513, and top surfaces of the wedge blocks 513 are inclined surfaces, the two wedge blocks 513 are staggered from each other in a vertical direction, and front and rear sides of the bottom housing 53 define strip grooves 531 arranged in arrays. The hot air in the bottom housing 53 can be easily discharged through the strip grooves 531. The placing box 51 is internally provided with a fixing member 54, and the fixing member 54 is internally provided with batteries 55 arranged in array, left and right sides of the placing box 51 are fixedly mounted with heat dissipation members 56. The heat dissipation member 56 includes fan covers 562 fixedly mounted on the left and right sides of the placing box 51, a fan 561 is arranged between the fan cover 562 and the side of the placing box 51, and an avoiding opening 563 extends through a surface of the fan cover 562. Two fans 561 rotate to supply air into the placing box 51, and the hot air in the placing box 51 is discharged through the airflow. The top housing 52 is fixedly mounted on the bottom of the C housing 4, and the bottom housing 53 is fixedly mounted on the top of the E housing 6.

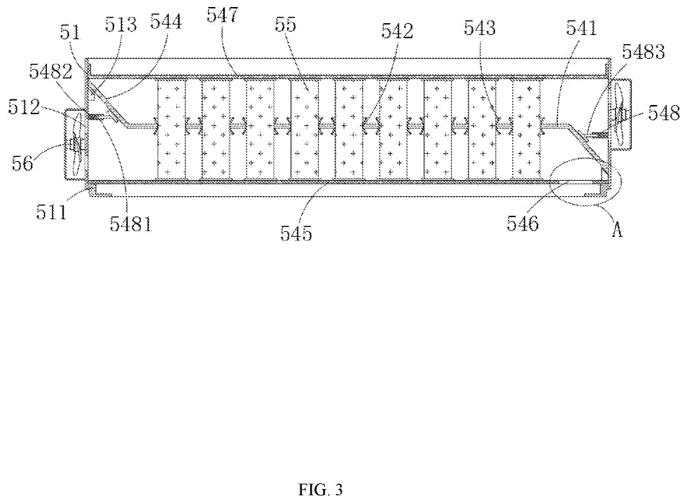

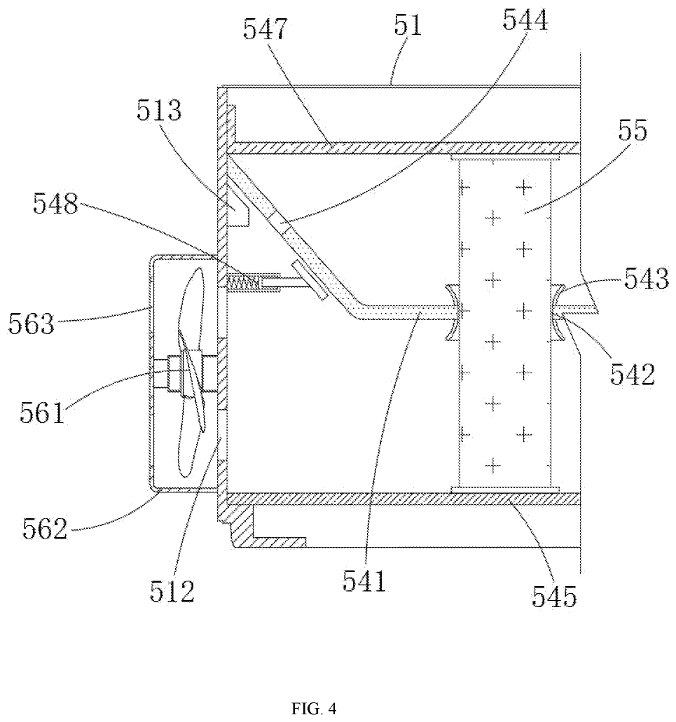

As shown in FIGS. 2-4, the fixing member 54 includes a fixing plate 541, a middle of the fixing plate 541 is horizontal, a left side of the fixing plate 541 inclines upward, a right side of the fixing plate 541 inclines downward, left and right sides of the fixing plate 541 are respectively butted on the tops of two wedge blocks 513, the middle of the fixing plate 541 defines circular holes 542 arranged in array, the batteries 55 are inserted in the circular holes 542. When the D housing 5 crashes with an object, and the batteries 55 tend to shake from left to right in the placing box 51, the batteries 55 will press the inclined part of the fixing plate 541 towards the left or the right as the top housing 52 is fixed and limited by the fixing plate 541, and the inclined part of the fixing plate 541 can prevent the batteries 55 from shaking to make the batteries 55 more stable. Opening parts 543 are provided on upper and lower sides of the fixing plate 541 and arranged at openings of the circular holes 542. It is more convenient to place the batteries in the circular holes 542 which are defined in the fixing plate 541 under a guidance of the opening parts 543. A through-hole 544 is defined on the left inclined surface of the fixing plate 541, a support plate 545 is arranged directly below the fixing plate 541 and butted on the base bracket 511, a guiding hole 546 is defined on the right side of the support plate 545, and a pressing plate 547 is arranged above the fixing plate 541 and butted on tops of the batteries 55, the battery 55 is fixed from the upper and lower sides of the battery 55 by the support plate 545 and the pressing plate 547 to fix the battery 55 more stably. The left and right sides of the fixing plate 541 and left and right side walls of the placing box 51 are provided with support parts 548. The support part 548 includes a sleeving tube 5481 fixedly mounted on a side wall of the placing box 51, an end face of the sleeving tube 5481 is fixedly mounted with a first spring 5482, the other end of the first spring 5482 is fixedly mounted with an inserting rod 5483, and an end of the inserting rod 5483 away from the first spring 5482 is inclined, and the inserting rod 5483 is butted against an inclined surface of the fixing plate 541. Through the elasticity of the first spring 5482, the inserting rod 5483 is supported on the inclined surface of the fixing plate 541, which further enhances the stability effect of the fixing plate 541 on the battery and prevents the battery 55 from shaking.

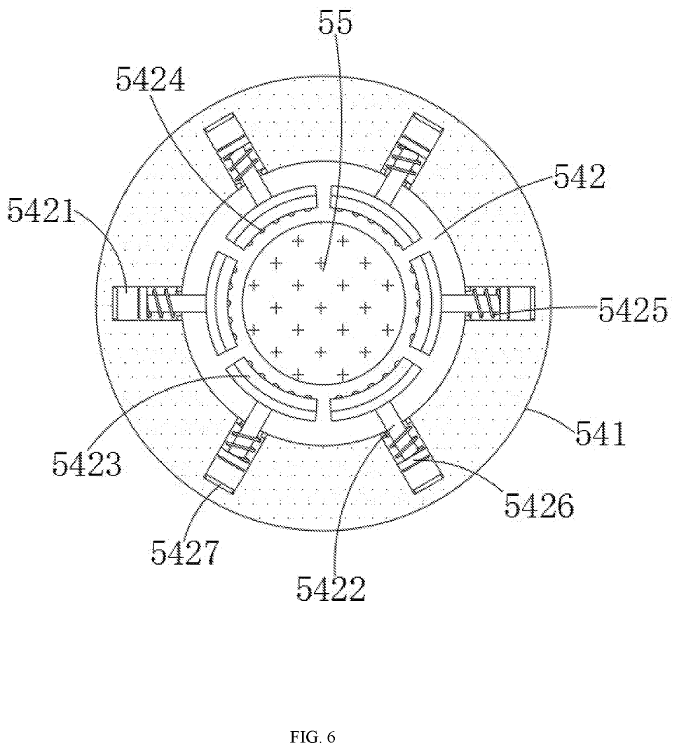

As shown in FIG. 6, mounting grooves 5421 arranged in an array are defined in a surface of the fixing plate 541 and defined in an inner wall of the circular hole 542, a sliding rod 5422 is slidably connected in the mounting groove 5421, an end of the sliding rod 5422 is fixedly mounted with an arc plate 5423, the arc plate 5423 butts against the surface of the battery 55, a side of the arc plate 5423 away from the sliding rod 5422 is arranged with rubber protrusions 5424 arranged in an array, a surface of the sliding rod 5422 is sleeved with a second spring 5425, two ends of the second spring 5425 are fixedly mounted on the surface of the sliding rod 5422 and an inner wall of the mounting groove 5421, the other end of the sliding rod 5422 is fixedly mounted with a contacting head 5426, a bottom of the mounting groove 5421 is provided with a contacting plate 5427, the contacting head 5426 is electrically connected with the contacting plate 5427, the D housing 5 is internally provided with an alarm, and the contacting head 5426, the contacting plate 5427 and the alarm are connected in series. Under normal conditions, the contacting head 5426 is not in contact with the contacting plate 5427. When the D housing 5 collides with an object and bulges, an assembly of the arc plate 5423, sliding rod 5422 and contacting head 5426 will be pushed to move towards the contacting plate 5427, so that the contacting head 5426 and the contacting plate 5427 are coupled with the circuit where the alarm is located, and the alarm gives an alarm.

When in use, the batteries 55 are stored in the circular holes 542 defined in the fixing plate 541. When the placing box 51 collides with an object and the batteries 55 tend to shake from left to right, the inclined parts on both sides of the fixing plate 541 are butted to the left and right side walls of the placing box 51, and the elasticity of the first spring 5482 is used to support the inserting rod 5483 on the inclined surface of the fixing plate 541 to prevent the batteries 55 from shaking.

The fans 561 on both sides rotate to blow wind into the placing box 51, and the fan 561 on the right blows wind to the left, the airflow flows from the upper half of the fixing plate 541 to the left of the fixing plate 541, flows through the gap between the batteries 55, then flows through the through hole 544 and flows towards the lower part of the fixing plate 541. The fan 561 on the right blows wind to the left, so that the airflow flows through the gap between the batteries 55, then flows through the guiding hole 546 into the bottom housing 53, then the airflow is discharged from the bottom housing 53 through the strip groove 531. So that an annular airflow is formed inside the placing box 51 under the separation and guidance of the fixing plate 541, the airflow distance is increased, and the heat dissipation effect of the battery 55 is ensured.

When the battery 55 bulges, the assembly of the arc plate 5423 and the sliding rod 5422 is pushed outward, so that the contacting head 5426 is in contact with the contacting plate 5427, the contacting head 5426 and the contacting plate 5427 are coupled with the circuit where the alarm is located, so that the alarm gives an alarm.

The above description is merely some embodiments. It should be noted that for one with ordinary skills in the art, improvements can be made without departing from the concept of the present disclosure, but these improvements shall fall into the protection scope of the present disclosure.

What is claimed is:

1. A battery block fixing device for an energy storage power supply, comprising an A housing (1), wherein a handle (2) is fixedly mounted on a top of the A housing (1), a bottom of the A housing (1) is provided with a B housing (3), a C housing (4), a D housing (5) and an E housing (6) in sequence, and the A housing (1), the handle (2), the B housing (3), the C housing (4), the D housing (5) and the E housing (6) are all detachably connected.

2. The battery block fixing device for an energy storage power supply according to claim 1, wherein the D housing (5) comprises a placing box (51), a top housing (52) is fixedly mounted on a top of the placing box (51), a bottom housing (53) is fixedly mounted on a bottom of the placing box (51), the placing box (51) is internally provided with a fixing member (54), and the fixing member (54) is internally provided with batteries (55) arranged in array, left and right sides of the placing box (51) are fixedly mounted with heat dissipation members (56), the top housing (52) is fixedly mounted on a bottom of the C housing (4), and the bottom housing (53) is fixedly mounted on a top of the E housing (6).

3. The battery block fixing device for an energy storage power supply according to claim 2, wherein an inner wall of a bottom of the placing box (51) is integrally formed with a base bracket (511), the left and right sides of the placing box (51) define air inlets (512) extending through the left and right sides, left and right side walls of the placing box (51) are fixedly mounted with wedge blocks (513), and top surfaces of the wedge blocks (513) are inclined surfaces, the two wedge blocks (513) are staggered from each other in a vertical direction, and front and rear sides of the bottom housing (53) define strip grooves (531) arranged in arrays.

4. The battery block fixing device for an energy storage power supply according to claim 2, wherein the fixing member (54) comprises a fixing plate (541), a middle of the fixing plate (541) is horizontal, a left side of the fixing plate (541) is inclined upward, a right side of the fixing plate (541) is inclined downward, and the left and right sides of the fixing plate (541) are respectively butted against the tops of two wedge blocks (513), the middle of the fixing plate (541) defines circular holes (542) arranged in array, the batteries (55) are inserted into the circular holes (542), opening parts (543) are provided on upper and lower sides of the fixing plate (541) and arranged at openings of the circular holes (542), a left inclined surface of the fixing plate (541) defines a through hole (544), and a support plate (545) is arranged directly below the fixing plate (541) and butted on the base bracket (511), a guiding hole (546) is arranged in a right side of the support plate (545), a pressing plate (547) is arranged above the fixing plate (541) and butted on tops of the batteries (55), and the left and right sides of the fixing plate (541) and left and right side walls of the placing box (51) are provided with support parts (548).

5. The battery block fixing device for an energy storage power supply according to claim 4, wherein mounting grooves (5421) arranged in an array are defined in a surface of the fixing plate (541) and defined in an inner wall of the circular hole (542), a sliding rod (5422) is slidably connected in the mounting groove (5421), an end of the sliding rod (5422) is fixedly mounted with an arc plate (5423), the arc plate (5423) is butted against a surface of the battery (55), a side of the arc plate (5423) away from the sliding rod (5422) is arranged with rubber protrusions (5424) arranged in an array, a surface of the sliding rod (5422) is sleeved with a second spring (5425), two ends of the second spring (5425) are fixedly mounted on the surface of the sliding rod (5422) and an inner wall of the mounting groove (5421), the other end of the sliding rod (5422) is fixedly mounted with a contacting head (5426), a bottom of the mounting groove (5421) is provided with a contacting plate (5427), the contacting head (5426) is electrically connected with the contacting plate (5427), the D housing (5) is internally provided with an alarm, and the contacting head (5426), the contacting plate (5427) and the alarm are connected in series.

6. The battery block fixing device for an energy storage power supply according to claim 4, wherein the support part (548) comprises a sleeving tube (5481) fixedly mounted on a side wall of the placing box (51), an end face of the sleeving tube (5481) is fixedly mounted with a first spring (5482), the other end of the first spring (5482) is fixedly mounted with an inserting rod (5483), and an end of the inserting rod (5483) away from the first spring (5482) is inclined, and the inserting rod (5483) is butted against an inclined surface of the fixing plate (541).

7. The battery block fixing device for an energy storage power supply according to claim 2, wherein the heat dissipation member (56) comprises fan covers (562) fixedly mounted on the left and right sides of the placing box (51), a fan (561) is arranged between the fan cover (562) and the side of the placing box (51), and an avoiding opening (563) extends through a surface of the fan cover (562), and the air inlet (512) communicates with the placing box (51) and the fan cover (562).
